(19) United States
(12) Patent Application Publication
(10) Pub. No.: US 2018/0288848 A1
(43) Pub. Date: Oct. 4, 2018

(54) VEHICLE IMAGING SYSTEMS AND METHODS FOR LIGHTING DIAGNOSIS

(71) Applicant: GM GLOBAL TECHNOLOGY OPERATIONS LLC, DETROIT, MI (US)

(72) Inventors: Xiujie GAO, Troy, MI (US); Jinsong WANG, Troy, MI (US); Wende ZHANG, Troy, MI (US); Donald K. GRIMM, Utica, MI (US); Jay H. OVENSHIRE, Rochester, MI (US); Gregory M. CASTILLO, Windsor (CA)

(21) Appl. No.: 15/471,492

(22) Filed: Mar. 28, 2017

(51) Int. Cl. H05B 33/08; H04N 7/18; G06K 9/62; B60R 1/00; B60R 25/24; B60Q 9/00

(52) U.S. Cl. CPC H05B 33/0884; H04N 7/183; G06K 9/6202; H05B 33/0845; B60R 1/00; B60Q 1/2696; B60Q 9/00; B60R 2300/105; B60R 2300/30; B60R 2300/804; B60R 2300/8086; B60R 25/24

(57) ABSTRACT

A vehicle includes a plurality of exterior lamps each arranged to cast a light pattern in a vicinity of the vehicle. The vehicle also includes at least one imaging device configured to capture image data indicative of the vicinity including at least one light pattern. The vehicle further includes a controller programmed to cause a variance action by a particular one of the plurality of exterior lamps, and monitor the image data for a change in a light pattern associated with the particular one of the exterior lamps. The controller is also programmed to generate a signal indicative of a fault condition associated with the particular one of the exterior lamps in response to no change in the light pattern.

### TECHNICAL FIELD

The present disclosure relates to vehicle imaging systems and methods for monitoring vehicle lighting operation.

### INTRODUCTION

Vehicle exterior lighting systems may include a number of lamps arranged to illuminate the vicinity of the vehicle to enhance driver visibility. Current exterior lighting system monitoring may include monitoring electrical values associated with a lighting circuit to detect anomalies. While electrical system monitoring may be partially effective, it may not detect exterior lighting issues unrelated to electrical parameters.

### SUMMARY

A vehicle includes a plurality of exterior lamps each arranged to cast a light pattern in a vicinity of the vehicle. The vehicle also includes at least one imaging device configured to capture image data indicative of the vicinity including at least one light pattern. The vehicle further includes a controller programmed to cause a variance action by a particular one of the plurality of exterior lamps, and monitor the image data for a change in a light pattern associated with the particular one of the exterior lamps. The controller is also programmed to generate a signal indicative of a fault condition associated with the particular one of the exterior lamps in response to no change in the light pattern.

A method of detecting performance of at least one exterior lamp includes emitting a light pattern from each of a plurality of exterior lamps, and collecting image data including a field of view capturing at least one light pattern. The method also includes causing a variance action by a particular one of the plurality of exterior lamps, and monitoring the field of view for a change in a light pattern associated with the particular one of the exterior lamps. The method further includes generating a signal indicative of a fault condition associated with the particular one of the exterior lamps in response to no change in the optical pattern.

A lamp diagnostic system is configured for a vehicle having a plurality of exterior lamps each emitting a light pattern. The lamp diagnostic system includes at least one imaging device configured to capture image data indicative of the vicinity and a controller programmed to capture a reference image including at least one light pattern. The controller is also programmed to cause a variance action by a particular one of the plurality of exterior lamps and to capture a variance image including the least one light pattern during the variance action. The controller is further programmed to compare the variance image to the reference image for a change in a light pattern. The controller generates a signal indicative of a fault condition associated with the particular one of the exterior lamps in response to no change in the light pattern during the variance action.

### BRIEF DESCRIPTION OF THE DRAWINGS

FIG. 1 is a side view of a vehicle having a vision system.

FIG. 2 is a user display depicting a first vehicle lighting operating condition.

FIG. 3 is a user display depicting a second vehicle lighting operating condition.

FIG. 4 is a user display depicting a third vehicle lighting operating condition.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

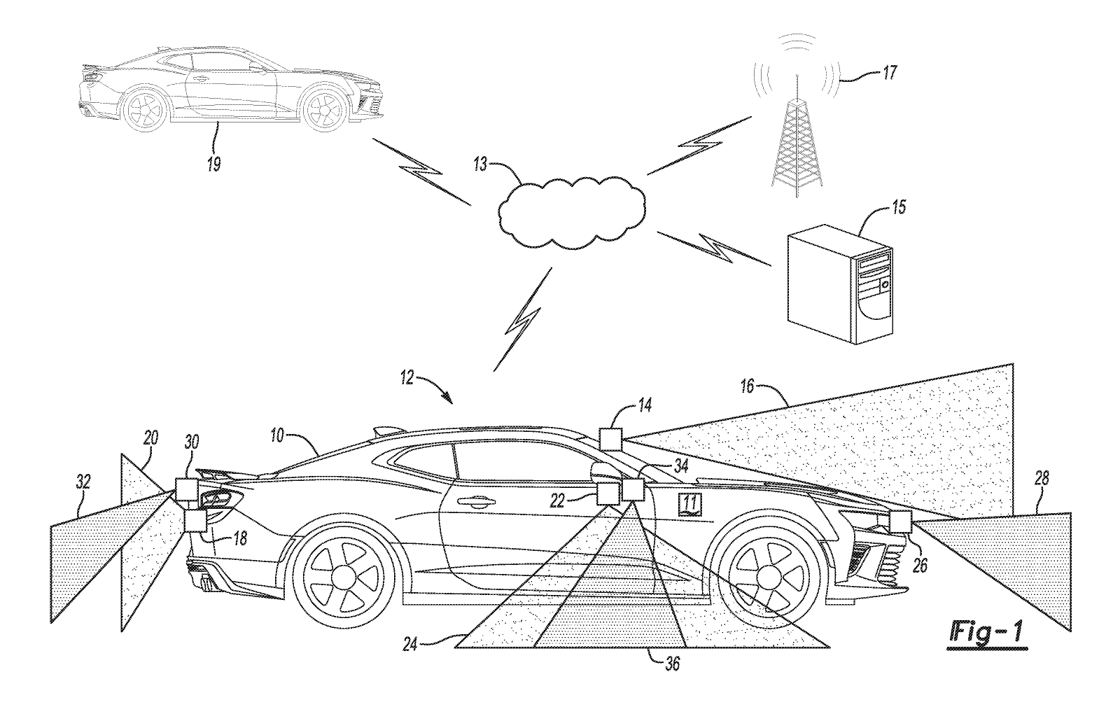

Referring to FIG. 1, a vehicle 10 includes a vision system 12 configured to capture image data in a plurality of regions surrounding the vehicle, including, but not limited to, images in a forward-facing direction, a rearward-facing direction, and/or or images in lateral-facing directions. The vision system 12 includes at least one vision-based imaging device to capture image data corresponding to the exterior of the vehicle 10 for detecting the vehicle surroundings. Each of the vision-based imaging devices is mounted on the vehicle so that images in a desired region of the vehicle vicinity are captured.

A first vision-based imaging device 14 is mounted behind the front windshield for capturing images representing the vehicle's vicinity in an exterior forward direction. In the example of FIG. 1, the first vision-based imaging device 14 is a front-view camera for capturing a forward field-of-view (FOV) 16 of the vehicle 10. In additional examples, an imaging device may be disposed near a vehicle grill, a front fascia, or other location closer to the forward edge of the vehicle. A second vision-based imaging device 18 is mounted at a rear portion of the vehicle to capture images representing the vehicle's vicinity in an exterior rearward direction. According to an example, the second vision-based imaging device 18 is a rear-view camera for capturing a rearward FOV 20 of the vehicle. A third vision-based imaging device 22 is mounted at a side portion of the vehicle to capture images representing the vehicle's vicinity in an exterior lateral direction. According to an example, the third vision-based imaging device 22 is a side-view camera for capturing a lateral FOV 24 of the vehicle. In a more specific example, a side-view camera is mounted on each of opposing sides of the vehicle 10 (e.g. a left side-view camera and a right side-view camera). It should be appreciated that while various FOV's are depicted in the Figures as having certain geometric patterns, actual FOV's may have any number of different geometries according to the type of imaging device which is employed in practice. In some examples, wide angle imaging devices are used to provide wide angle FOV's such as 180 degrees and wider. Additionally, while each of the cameras is depicted as being mounted on the vehicle, alternate examples include external cameras having FOV's which capture the surrounding environment of the vehicle.

The cameras 14, 18, and 22 can be any type of imaging device suitable for the purposes described herein, that are capable of receiving light, or other radiation, and converting the light energy to electrical signals in a pixel format using, for example, charged coupled devices (CCD). Each of the cameras may also be operable to capture images in various regions of the electromagnetic spectrum, including infrared, ultraviolet, or within visible light. The cameras may also be operable to capture digital images and/or video data in any suitable resolution including high-definition. As used in the present disclosure, image data provided by the image capture devices includes either individual images or a stream of video images. The cameras may be any digital video recording device in communication with a processing unit of the vehicle. Image data acquired by the cameras is passed to the vehicle processor for subsequent actions. For example, image data from the cameras 14, 18, and 22 is sent to a processor, or vehicle controller 11, which processes the image data. In the case of external cameras, image data may be wirelessly transmitted to the vehicle controller 11 for use as described in any of the various examples of the present disclosure. As discussed in more detail below, the vehicle processor 11 may be programmed to generate images and other graphics at a user display such as, for example, a console screen or at a review mirror display device.

The various vision system components discussed herein may have one or more associated controllers to control and monitor operation. The vehicle controller 11, although schematically depicted as a single controller, may be implemented as one controller, or as system of controllers in cooperation to collectively manage the vision system and other vehicle subsystems. Communication between multiple controllers, and communication between controllers, actuators and/or sensors may be accomplished using a direct wired link, a networked communications bus link, a wireless link, a serial peripheral interface bus or any another suitable communications link. Communications includes exchanging data signals in any suitable form, including, for example, electrical signals via a conductive medium, electromagnetic signals via air, optical signals via optical waveguides, and the like. Data signals may include signals representing inputs from sensors, signals representing actuator commands, and communications signals between controllers. In a specific example, multiple controllers communicate with one another via a serial bus (e.g., Controller Area Network (CAN)) or via discrete conductors. The controller 11 includes one or more digital computers each having a microprocessor or central processing unit (CPU), read only memory (ROM), random access memory (RAM), electrically-programmable read only memory (EPROM), a high speed clock, analog-to-digital (A/D) and digital-to-analog (D/A) circuitry, input/output circuitry and devices (I/O), as well as appropriate signal conditioning and buffering circuitry. The controller 11 may also store a number of algorithms or computer executable instructions in non-transient memory that are needed to issue commands to perform actions according to the present disclosure. In some examples algorithms are provided from an external source such as a remote server 15.

The controller 11 is programmed to monitor and coordinate operation of the various vision system components. The controller 11 is in communication with each of the image capturing devices to receive images representing the vicinity of the vehicle and may store the images as necessary to execute exterior lighting diagnosis algorithms described in more detail below. The controller 11 is also in communication with a user display in an interior portion of the vehicle 10. The controller is programmed to selectively provide pertinent images to the display to inform passengers about lighting conditions in the vicinity of the vehicle 10. While image capturing devices are described by way of example in reference to the vision system, it should be appreciated that the controller 11 may also be in communication with an array of various sensors to detect external objects and the overall environment of the vehicle. For example, the controller may receive signals from any combination of radar sensors, lidar sensors, infrared sensors, ultrasonic sensors, or other similar types of sensors in conjunction with receiving image data. The collection of data signals output from the various sensors may be fused to generate a more comprehensive perception of the vehicle environment, including detection and tracking of external objects.

The controller 11 may also be capable of wireless communication using a transceiver or similar transmitting device. The transceiver may be configured to exchange signals with a number of off-board components or systems. The controller 11 is programmed to exchange information using a wireless communications network 13. Data may be exchanged with a remote server 15 which may be used to reduce on-board data processing and data storage requirements. In at least one example, the server 15 performs processing related to image processing and analysis. The server may store one or more model-based computation algorithms to perform vehicle security enhancement functions. The controller 11 may further be in communication with a cellular network 17 or satellite to obtain a global positioning system (GPS) location. The controller 11 may also be in direct wireless communication with objects in a vicinity of the vehicle 10. For example, the controller may exchange signals with various external infrastructure devices (i.e., vehicle-to-infrastructure, or V2I communications) and/or a nearby vehicle 19 to provide data acquired from the vision system 12, or receive supplemental image data to further inform the user about the vehicle environment.

The vision system 12 may be used for recognition of road markings, lane markings, road signs, or other roadway objects for inputs to lane departure warning systems and/or clear path detection systems. Identification of road conditions and nearby objects may be provided to the vehicle processor to guide autonomous vehicle guidance. Images captured by the vision system 12 may also be used to distinguish between a daytime lighting condition and a nighttime lighting condition. Identification of the daylight condition may be used in vehicle applications which actuate or switch operating modes based on the sensed lighting condition. As a result, the determination of the lighting condition eliminates the requirement of a dedicated light sensing device while utilizing existing vehicle equipment. In one example, the vehicle processor utilizes at least one captured scene from the vision system 12 for detecting lighting conditions of the captured scene, which is then used as an input to lighting diagnosis procedures.

With continued reference to FIG. 1, the vehicle 10 also includes a plurality of external lamps each configured to emit light in the vehicle vicinity to enhance driver visibility, as well as visibility of vehicle 10 to other vehicles and pedestrians. At least one front exterior lamp 26 emits light in a forward direction of the vehicle 10. The emitted light casts a light pattern 28 in a front portion of the vicinity of the vehicle 10. While a single lamp is schematically depicted in FIG. 1 for illustration purposes, a combination of any number of lamps may contribute to an aggregate light pattern in the front portion of the vicinity of the vehicle 10. For example, the front exterior lamps may include at least low beams, high beams, fog lamps, turn signals, and/or other forward lamp types to cast an aggregate front light pattern 28. Further, the light pattern 28 is cast onto the ground or onto nearby objects in front of the vehicle, and is included in image data captured by the first vision-based imaging device 14.

The vehicle 10 also includes a plurality of rear exterior lamps 30 to emit light in a rearward direction of the vehicle 10. Similar to the front of the vehicle, any number of a combination of lamps may contribute to an aggregate light pattern in the rear portion of the vicinity of the vehicle 10. For example, the rear exterior lamps may include at least rear lamps, brake signal lamps, high-mount lamps, reverse lamps, turn signals, license plate lamps, and/or other rear lamp types to cast an aggregate rear light pattern 32. Further, the light pattern 32 is cast onto the ground or onto nearby objects behind the vehicle, and is included in image data captured by the second vision-based imaging device 18.

The vehicle 10 may further include at least one lateral exterior lamp 34 to emit light in a lateral direction of the vehicle 10. Similar to the front and rear of the vehicle, any number of a combination of lamps may contribute to an aggregate light pattern in a side portion of the vicinity of the vehicle 10. For example, the at least one lateral exterior lamp 34 may include turn signal indicators, side mirror puddle lamps, side marker lamps, ambient lighting, and other types of side lamp to cast an aggregate lateral light pattern 36 which is included in image data captured by the third vision-based imaging device 22. Each of the FOV's of the vision system 12 may capture any combination of the plurality of light patterns emitted from the exterior lamps.

According to aspects of the present disclosure, an exterior lamp diagnosis algorithm may be used in combination with the acquisition of image data to provide advanced warnings and other actions in response to detection of one or more lamp fault conditions. In some examples, the vehicle controller 11 may be programmed to assess performance of a plurality of exterior lamps using data acquired by the vision system 12 by engaging an exterior lamp diagnosis mode. Diagnosis mode as used in the present disclosure refers to algorithms which actively probe the vehicle vicinity for expected lamp output and make determinations regarding lamp faults when actual output does not comport with expected output. According to a specific example, the vehicle may undergo a self-diagnostic procedure as part of a lamp initialization, for example around the time of a vehicle startup. This lamp initialization may be performed in advance of vehicle startup such as in response to detecting an approaching driver key fob. The controller may anticipate upcoming use of one or more exterior lamps and perform self-diagnosis to ensure proper lamp function. Additionally, a vehicle user display may be used to provide additional FOV information to enhance driver assurance with respect to exterior lamp performance.

The controller may be programmed to diagnose faults of individual lamps by issuing a command causing a variance action by a particular one of the plurality of exterior lamps. Other portions of the controller algorithm include the controller monitoring the image data provided from the vision system for a change in an aggregate light pattern containing the individual light pattern of the particular one lamp being evaluated. In some examples, the controller is programmed to capture a reference image including the light pattern being evaluated prior to causing a variance action by a particular one lamp. During the variance action, the controller captures a variance image including the light pattern of the lamp performing the variance action.

The controller may then compare the variance image to the reference image for a change in a light pattern. If the particular one lamp being tested was operating properly prior to the test, the variance in lamp operation will manifest as a change in the individual light pattern associated with the particular lamp. And, changes in an individual light pattern are optically detectable by monitoring one or more FOV's. Such changes in response to the command for the variance action provide confirmation of a properly functioning lamp.

Conversely, if there is no change in the aggregate light pattern in response to the command for a variance action of a particular one of the plurality of lamps, it may be indicative of a fault condition associated with the lamp. Portions of an algorithm stored on the controller may include the controller generating a signal indicative of a fault condition associated with the particular one of the exterior lamps in response to no change in the aggregate light pattern. As discussed in more detail below, any number of techniques may be used to determine whether a change has occurred in the light pattern.

In one example, the controller is programmed to assess a quantity of pixels which have changed between a reference image and a variance image. More specifically, a change in a light pattern may be detected when a number of changed pixels exceeds pixel change threshold. With reference to assessing individual pixels, individual color component values (e.g., red-green-blue, or RGB values) may be used to determine whether or not a given pixel has changed. As discussed in more detail below, the color component values may also be used to detect various color tones expected to be present in one or more FOV's.

In other examples, the controller may be programmed to monitor for changes at a particular target area within a FOV. Certain of the aggregate light patterns will have non uniform light dispersion such that an individual light pattern of a given lamp will illuminate the particular target area with more intensity than other areas of the aggregate light pattern. Thus the algorithm may include assessing a predetermined target area within a light pattern to gauge performance of a particular lamp.

In further examples, the controller may be programmed to acquire a series of images over a span of time. The images may be stored in memory with associated time stamp data and event data indicating which lamps are on. A group of the closest matching images may be stitched or otherwise merged then used as a reference image to compare against a variance image. In alternative examples, the controller may store in a memory, a number of different images corresponding to known proper lamp operating conditions. Once a variance image is obtained, the controller may select from the number of different images, the image most similar to the conditions presented in the variance image. More specifically, images from previous times and/or other locations may be sufficient to assess lamp performance if the environment of the previously-stored image is similar enough to that of the variance image.

A number of different variance actions may be employed to induce a visually-detectable change in a light pattern. In a first example the controller may be programmed to cause a variance action comprising temporarily activating and/or deactivating one of the plurality of exterior lamps as part of a diagnosis procedure to determine proper function. For instance, around the time of vehicle startup, and while the vehicle is stationary, the vision system may acquire first image data while a given lamp commanded to be active, as well as second image data while the lamp is commanded to be inactive. Whether or not there is a difference between the first image data and the second image data is indicative of proper function of the tested exterior lamp. According to some aspects, a lamp diagnosis algorithm includes flashing one or more lamps as a variance action to induce a change in a FOV if the lamp is operating properly. In the case of an inoperative lamp (e.g., a burned out lamp) no change in the FOV will be induced by commanding a flash of the inoperative lamp. In further examples, a plurality of exterior lamps may be sequentially tested such that a series of variance actions may be optically distinguished from one another.

In some cases, any number of the lamps may include light emitting diode (LED) style bulbs. Such LED lamps may also be paired with a pulse width modulation (PWM) driver to rapidly cycle supply current to enhance the output of the LED lamp. The frequency of the PWM cycling is high enough to appear as solid light emission to the human eye. According to aspects of the present disclosure, the variance action may include deliberately varying the PWM frequency of a given bulb and monitoring for changes in the light pattern. Variances in the PWM pulse frequency may be optically detected by the vision system as a change in the light pattern. According to some examples, individual lamps may be assigned unique PWM frequencies for their corresponding variance action such that when the variance action is performed, the vision system may optically detect the output of individual lamps. According to other examples, a nominal PWM frequency of a lamp may be from about 200 Hz to about 1,000 Hz. The variance action may include adjusting the PWM frequency to about 10 Hz for a short duration of about 300 milliseconds, or three periods, to induce a change in the light pattern. Following the variance action the controller may cause the PWM frequency to return to a nominal value.

In other examples, varying a PWM duty cycle may be included as part of the variance action. The term duty cycle refers the proportion of power delivery time, or “on” time, relative to the full periodic interval or “period” of time. Lower duty cycles correspond to low power, as the power is off for a majority of the time. Duty cycle may be expressed as a percentage value, with 100% being fully on. Different PWM duty cycles for a given exterior lamp may be perceived as causing different light intensity. A change in intensity of one or more light patterns can serve to improve the fidelity of the optical detection of the presence of the light pattern by the vision system. In some examples, the variance action comprises varying an intensity of a particular one of the plurality of exterior lamps, and monitoring for changes in a light pattern of an image.

Also for LED lamps which operate using PWM, the controller may vary an image sampling rate of the vision system to cause aliasing of one or more portions of the image. Temporal aliasing of the image data may be perceived as strobing and/or a visual distortion, also referred to as a “wagon wheel effect.” As discussed above, various external lamps may have unique PWM operating frequencies. Sweeping the sampling rate of the vision system may cause sequential aliasing of different single light pattern images according to different corresponding vision system sampling rates. Such forced aliasing may be optically detected as a change in the light pattern. If a lamp is not properly emitting light using PWM control, there won't be aliasing of the image when the vision system image sampling rate is at a known frequency which should otherwise cause aliasing.

The vision system may also rely on the acquisition of color image data by the image capture devices. For example the controller may be programmed to detect different color portions of the aggregate light patterns that correspond to individual lights that emit different colors. For example. headlamps emit generally white light, whereas brake lamps emit red light, and turn signals commonly emit amber light. Portions of a light pattern having a predetermined color tone may be diagnosed by detecting either the presence or the absence of an expected color tone. An absence of the expected color tone corresponding to a given vehicle condition may be indicative of an exterior lamp fault. In further examples, a given lamp may be arranged to selectively emit more than one color. In this case a variance action may include varying a color tone of the particular exterior lamp to monitor an image for a change in the light pattern.

In some further examples, one or more lamp bodies are positioned directly within the field of view of an imaging device. In this way, the vision system may directly detect light output of the lamp and/or the occurrence of any corresponding variance actions. The controller may be programmed to optically detect the direct emission of light or the presence of a fault condition.

In further still examples, an aim of a bulb may be adjusted to change the direction of the corresponding individual light pattern. For example, active head lamps may be configured to automatically aim a light pattern left or right from a nominal forward aim based on a turning direction of the vehicle while driving. Such auto-aiming lamps may include actuator motors arranged to physically change the direction of aim of the headlamps. Such actuator motors may be used during a lamp diagnosis procedure to cause a variance action where the light pattern of a given lamp moves according to motor actuation.

The lamp diagnosis algorithm may be configured to automatically execute around the time of a vehicle startup as part of a lamp initialization procedure. Any of the diagnosis procedures discussed herein may be executed when the vehicle is started and prior to being shifted into a motive gear. Alternatively, the procedure may be performed in response to an approaching driver key fob or user input at the key fob. Also, the procedure may be performed before or after a car sharing reservation (as part of a pre/post-diagnostic procedure or as instructed by the remote service at any time). Alternatively, the remote sever itself may be programmed to perform exterior lamp diagnosis off-board of the vehicle itself. While the vehicle is stationary, one or more images are captured before a lamp to be evaluated is triggered on, and captured again after the lamp is off. The off-board server may store algorithms to analyze and compare the images to determine the proper function of the exterior lamps. Further still, one or more vehicle lamps may be activated in response to unlocking of vehicle doors or the opening of at least one door. Generally there may be at least several seconds between the time which the lights are activated and the vehicle transitioned in to a motive state. During this time, any of the lamp diagnostic procedures may be performed to assess exterior lamp performance.

Also, certain vehicle operations may include causing one or more lamps to emit light after being in an inactive state. For example, shifting of a transmission into a reverse gear causes rear reverse lamps to illuminate after being inactive. And, as the vehicle is commonly shifted into reverse from a non-moving state, there is a window of time when the rear reverse lamps are illuminated and the vehicle is stationary. This window of time prior to departure from the non-moving state may be sufficient for the controller to execute a lamp diagnosis procedure on the rear backup lamps by inducing a variance action as discussed above. In a second example, a side marker begins to flash illuminate in response to a user input at a turn signal switch. And, there are vehicle scenarios such as sitting at rest at a traffic light where a flashing turn signal may be activated. The controller may be programmed to compare images from times when the turn signal lamp is intended to be illuminated to images from times between flashes when the turn signal lamp is intended to be inactive. As discussed above, sufficient differences in the light pattern between the images may indicate that the turn signal lamp is operating properly. Conversely, differences in the light pattern between the two images which are less than a threshold may indicate a fault condition associated with the turn signal lamp.

In further examples the controller may be programmed to automatically execute one or more lamp diagnosis procedures based on vehicle location information. The controller may be configured to determine a present location signature of the vehicle and storing it for later reference as a vehicle “home” position. The present location of the vehicle may be determined from a number of available sources. A location portion of the algorithm may include compiling multiple location indicators from different sources. Specifically, a vehicle controller may store location information received from at least one of a GPS location, a vehicle telecommunications module, a user mobile device, a local Wi-Fi network (e.g., an SSID of a WLAN transmission), as well as other connected vehicle data sources. Compilation of the multiple sources of location data may operate to provide a specific combination of location data which serves as a home location signature. While the term home position is used in the present disclosure, it should be appreciated that a driver may set a “home” vehicle position as a reference vehicle position for any location to which the driver would like to return at a later time. At a subsequent time, the lamp diagnosis procedure may include recognizing that the vehicle is located at a designated home vehicle position. The home location may be suitable to execute the lamp diagnosis procedures using image data from a previous instance of the vehicle being located at the home location.

Ambient light detection may be used as an additional input as to whether or not to perform lamp diagnosis algorithm. The degree of visibility of light patterns emitted from external lamps is sensitive to the amount of ambient light present. Specifically, data output from a light sensor may be used to apply weighting based on the light level in the area near the vehicle. In this case, where more dark areas are present near the vehicle, the lamp diagnosis may be automatically engaged to monitor lamp performance in the dark areas where the emitted light pattern is more optically detectable. In contrast, more well-lit areas in the vehicle vicinity (even at night time) may reduce the efficacy of diagnosing lamp performance. As discussed above, the image capture devices themselves may also be used for effective light level detection by analyzing a light level of the image data acquired by the devices.

In further examples, detection of moving external objects in the vicinity of the vehicle may cause the controller to abort a lamp diagnosis procedure. That is, an object that changes position within the field of view may cause a misleading change between the reference image and the variance image. Such a change caused by external objects may lead to incorrect conclusions about lamp performance. According to aspects of the present disclosure the controller is programmed to forego a lamp diagnosis procedure in response to detecting a moving object within a field of view.

The vehicle may undergo any of a number of response actions based on detecting a fault condition associated with one or more external lamps. Minor responses may include emitting an audible alert to the driver. In some cases visual alerts are provided such as messages at a display screen, or provided by automatically displaying images depicting the current surroundings of the vehicle. Further actions may include automatically transmitting a fault message to a user mobile device or to a remote server.

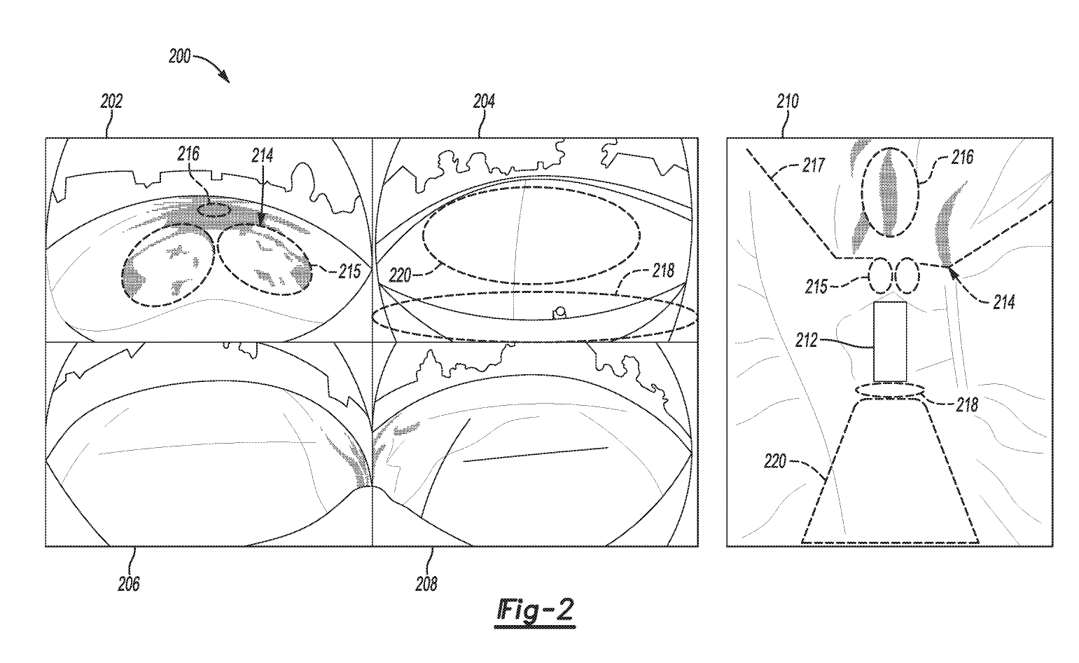

Referring to FIG. 2, a user display 200 is arranged to depict a plurality of FOV's output from image capture devices of the vision system. The display 200 may include a number of FOV's such as front FOV 202, rear FOV 204, left FOV 206, and right FOV 208. Additionally, a top FOV 210 represents a compiled view having image data from several FOV's stitched together to provide a “bird's eye” 360 degree top perspective of the vicinity in a single view. The host vehicle is schematically represented by a vehicle graphic 212. In the example of FIG. 2, a plurality of exterior lamps cast light patterns in the vicinity of the vehicle. The individual light patterns from the various external lamps are present within the FOV's 202 through 210 and collectively create aggregate light patterns. More specifically, front headlamps lamps cast front light pattern 214 most prominently visible in front FOV 202 and top FOV 210. The light pattern 214 may include several portions including focused low-beam portions 215 having higher intensity as well as wider light distribution portions 217 of the overall pattern. The front light pattern may also include focal area 216 used to assess proper headlamp function as discussed above. For example, an induced variance action may cause a difference in appearance of the focal area 216 to indicate that the front headlamps were properly functioning prior to the variance action.

A rear license plate lamp casts a local light pattern 218 near a rear bumper of vehicle 212. In combination, rear brake lamps may be selectively activated in response to driver application of a brake pedal and cast a light pattern 220 rearward of the vehicle 212.

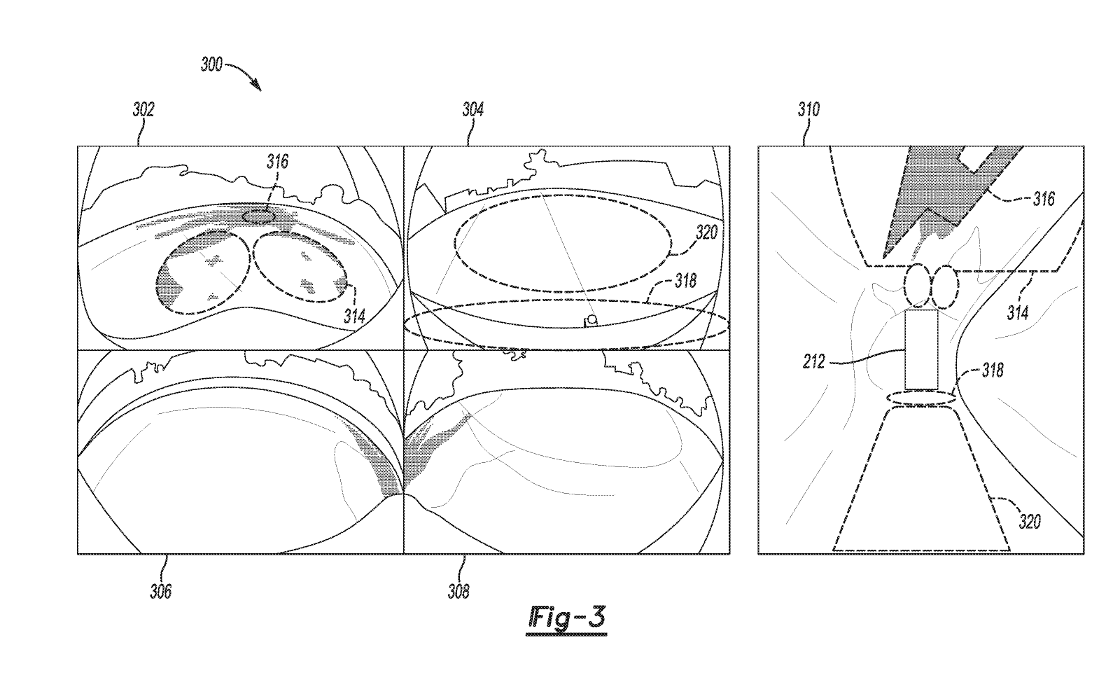

Referring to FIG. 3, user display 300 depicts at least one visual change in the exterior light patterns based on different vehicle operating conditions. Vehicle 212 may be equipped with active headlamps which automatically adjust the direction of emitted light during turning to coincide with a driver area of interest to enhance visibility during the turn. Both of front FOV 302 as well as composite FOV 310 depict the headlamp turning light pattern 314 during a turn maneuver of the host vehicle 212. The overall aggregate light pattern has shifted toward the right side of the vehicle as compared to the default light pattern 214 shown in FOV 202 and FOV 210 of FIG. 2. It should also be appreciated that in the example provided, the active headlamps have caused the shape and orientation of a light focal area 316 to vary. The performance of the active headlamp system may be assessed by monitoring a change in the light pattern direction of the headlamps. In other examples, any of a number of exterior lamps may be equipped with mechanisms to vary the direction of an individual light pattern. Thus the variance action used to assess the presence of a fault condition of a particular one of the plurality of exterior lamps may include changing a light pattern direction of the particular one lamp, and monitoring a field of view for changes using the vision system.

FIG. 3 also depicts a change in a light pattern rearward of the host vehicle 212 in rear FOV 304. A change in a portion of light pattern 320 corresponds to brake lamps changing state to become inactive in FIG. 3 from being active in FIG. 2. Such a change in the light pattern 320 associated with the variance action of activating and/or deactivating the brake lamps may indicate proper function of the brake lamps. It should be appreciated that the variance action may be activation and/or deactivation of the brake lamps to detect a change in the light pattern. That is, proper function may be indicated by changing state from active as shown in rear FOV 204 to inactive as shown in rear FOV 304, or vice versa. According to other aspects, it should also be appreciated that the light pattern 318 associated with a license plate lamp remains unchanged. An independent variance action associated with the particular lamp may be induced to check for fault conditions where the vision system monitors those specific corresponding areas of the FOV.

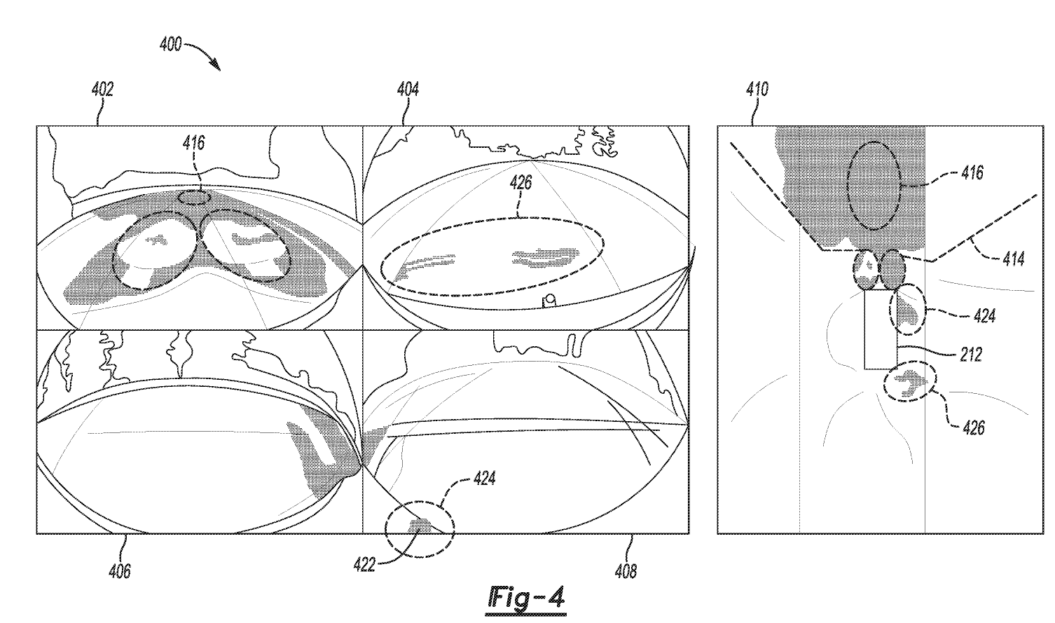

Referring to FIG. 4, other vehicle operating conditions indicate changes in one or more light patterns. Right FOV 408 is arranged to include a lamp body as light emission source 422. In the example of FIG. 4, the lamp body light emission source is a turn signal lamp. That is, the turn signal lamp is located to be directly within right FOV 408. The light pattern detected by the lateral image capture device includes light directly emitted by the turn signal lamp, in addition to light reflected from the ground or other objects in the vicinity of the host vehicle 212. With specific reference to FIG. 4, the light emission source 422 of the side turn signal lamp is directly shown to emit light, thus changing the light pattern captured by right FOV. A change in the light pattern may be detected relative to FOV 208 of FIG. 2 where the turn signal lamp is inactive. Such a change in the light pattern is an indication of proper function of the side turn signal lamp. Conversely, in response to no change in the light pattern when the user has provided input at a turn signal switch, a fault signal may be generated related to an improper function of the turn signal. Similar to previous examples, the lamp diagnosis algorithm may be configured to analyze a particular focus area 424 corresponding to direct emitted light of one or more exterior lamps.

With continued reference to FIG. 4, an additional lamp is activated in response to user input at the turn signal switch. A rear turn lamp is also activated and casts a light pattern 426 toward the ground in a right rear vicinity of the host vehicle 212. The light pattern 426 is visible in rear FOV 404, as well as top FOV 410. The light pattern 426 may also appear as either a persistent light pattern or a flashing pattern while the turn signal is active according to various examples. However, the change in the light pattern between an active state and an inactive state may be detected by the vision system as an indicator of proper lamp function.

Aspects of the present disclosure are useful not only to diagnose lamp faults, but are also useful to detect conditions where a light pattern of one or more lamps is obstructed. For example accumulation of snow, ice, or other debris over a lamp may obstruct a light pattern causing less than optimal driver visibility. The vision system according to the present disclosure is configured to detect such obstruction condition and generate a fault condition signal to make a user aware of the absence of emitted light.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. The processes, methods, and algorithms described above may be repeated at periodic or aperiodic intervals and examples provided in the present disclosure are not limited in the frequency under which the processes are executed

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a plurality of exterior lamps each arranged to cast a light pattern in a vicinity of the vehicle;
at least one imaging device configured to capture image data indicative of the vicinity including at least one light pattern; and
a controller programmed to
cause a variance action by a particular one of the plurality of exterior lamps,
monitor the image data for a change in a light pattern associated with the particular one of the exterior lamps, and
in response to no change in the light pattern, generate a signal indicative of a fault condition associated with the particular one of the exterior lamps.

2. The vehicle of claim 1 wherein the variance action comprises varying an intensity of the particular one of the plurality of exterior lamps.

3. The vehicle of claim 1 wherein the variance action comprises varying a pulse frequency of the particular one of the plurality of exterior lamps.

4. The vehicle of claim 3 wherein each of the plurality of exterior lamps is varied to a distinct pulse frequency different from other ones of the plurality of exterior lamps.

5. The vehicle of claim 1 wherein the controller is further programmed to cause the variance action as part of a lamp initialization procedure.

6. The vehicle of claim 5 wherein the lamp initialization procedure is prompted by detection of an approaching key fob.

7. The vehicle of claim 1 wherein a field of view of the at least one imaging device is arranged to include a lamp body within a direct field of view.

8. The vehicle of claim 1 further comprising a user interface display configured to display image data from the at least one imaging device to provide a user indication of an exterior lamp status.

9. A method of detecting performance of at least one exterior lamp comprising:
emitting a light pattern from each of a plurality of exterior lamps,
collecting image data including a field of view capturing at least one light pattern;
causing a variance action by a particular one of the plurality of exterior lamps,
monitoring the field of view for a change in a light pattern associated with the particular one of the exterior lamps;
in response to no change in the optical pattern, generating a signal indicative of a fault condition associated with the particular one of the exterior lamps.

10. The method of claim 9 wherein the variance action comprises varying an intensity of the particular one of the plurality of exterior lamps.

11. The method of claim 9 wherein the variance action comprises varying a pulse frequency of the particular one of the plurality of exterior lamps.

12. The method of claim 9 further comprising causing the variance action as part of a lamp initialization procedure.

13. The method of claim 12 wherein the lamp initialization procedure is prompted by detection of an approaching key fob.

14. The method of claim 9 wherein the field of view is arranged to include a light emission source.

15. The method of claim 9 wherein the variance action includes changing a sample rate of collecting image data to induce aliasing of one or more light patterns within the field of view.

16. A lamp diagnostic system for a vehicle having a plurality of exterior lamps each emitting a light pattern, the lamp diagnostic system comprising:
at least one imaging device configured to capture image data indicative of the vicinity; and
a controller programmed to
capture a reference image including at least one light pattern,
cause a variance action by a particular one of the plurality of exterior lamps,
capture a variance image including the least one light pattern during the variance action,
compare the variance image to the reference image for a change in a light pattern, and
in response to no change in the light pattern during the variance action, generate a signal indicative of a fault condition associated with the particular one of the exterior lamps.

17. The lamp diagnostic system of claim 16 further comprising a user interface display configured to display image data from the at least one imaging device to provide a user indication of an exterior lamp status.

18. The lamp diagnostic system of claim 16 wherein the change in a light pattern comprises a light intensity decrease greater than an intensity threshold in a predefined zone within the variance image corresponding to the particular one of the plurality of exterior lamps.

19. The lamp diagnostic system of claim 16 wherein the variance action comprises changing a light pattern direction of the particular one of the plurality of exterior lamps.

20. The lamp diagnostic system of claim 16 wherein the variance action comprises automatically activating an inactive lamp to diagnose a lamp status.
